(19) United States
(12) Patent Application Publication
(10) Pub. No.: US 2016/0074779 A1
(43) Pub. Date: Mar. 17, 2016

(54) INLET ELBOW WITH CURVED SCREEN

(71) Applicant: SIEBTECHNIK GMBH, Mulheim an der Ruhr (DE)

(72) Inventor: Horst Dietschreit, Mulheim an der Ruhr (DE)

(73) Assignee: SIEBTECHNIK GMBH, Mulheim an der Ruhr (DE)

(21) Appl. No.: 14/852,596

(22) Filed: Sep. 13, 2015

(30) Foreign Application Priority Data
Sep. 16, 2014 (DE) 10 2014 013 438.5

(51) Int. Cl. B01D 29/00; B04B 1/20

(52) U.S. Cl. CPC B01D 29/0097; B04B 1/20

(57) ABSTRACT

The invention relates to an inlet elbow (1), in particular for a screen centrifuge, whereby the inlet elbow (1) comprises a bend (8) in which material to be transported is deflected and wherein the bend (8) comprises a curved screen (6) by means of which liquid is removed from the material and discharged.

### CROSS-REFERENCE TO RELATED APPLICATIONS

The present application claims the priority benefit of German Application No. 10 2014 013 438.5 filed Sep. 16, 2014, the entirety of which is incorporated herein by reference.

The invention relates to an inlet elbow, in particular for a screen centrifuge, as well as to a method for dewatering a wet granulate, in particular a wet plastic granulate, in particular by means of a screen centrifuge.

Such inlet elbows and methods for dewatering a wet granulate are known. Here, for example, the material to be processed is fed to a screen centrifuge via an inlet elbow in which centrifuge dewatering of the wet granulate is carried through. Here, the performance of the screen centrifuge is limited by the water load of the wet material.

The object of the invention is to provide an inlet elbow, in particular for a screen

centrifuge, as well as a method for dewatering a wet granulate, which exhibits an improved performance characteristic.

According to the invention, said object is achieved by means of an inlet elbow

according to claim 1, a screen centrifuge according to claim 13 as well as a

method according to claim 14. Advantageous further developments of the invention are indicated in the dependent claims.

With regard to the inlet elbow, in particular for a screen centrifuge, it is particularly advantageous that the inlet elbow comprises a bend in which material to be transported is deflected and wherein the bend comprises a curved screen by means of which liquid is removed from the material and discharged. Thus, the liquid can be discharged separately.

In the present case, the term material comprises in particular a granulate such as a plastic granulate, for example.

Here, it is particularly advantageous that a pre-drying of the wet granulate is effected by means of the inlet elbow having a curved screen before said granulate is routed for further dewatering, via which screen a material to be fed to a screen centrifuge is channeled for further dewatering. As a result of the fact that a significant part of liquid is removed from the granulate to be dewatered in the scope of the pre-drying by means of the inlet elbow, the performance of the screen centrifuge, which may be disposed downstream said elbow, is significantly increased. Here, the term dewatering refers to any form of removal of liquid, wherein said liquid is not limited to water. In fact, it may be any other liquid or a mixture containing water and, for example, a solvent or the like.

Preferably, the inlet elbow is gas-tight toward the surroundings. Preferably, the curved screen is formed by a screen which in its contour corresponds to the bend of the inlet elbow.

Correspondingly, liquid can be removed and discharged from the wet granulate to be dewatered by means of the curved screen in the region of the inlet elbow in which the material to be transported is deflected.

Preferably, the curved screen comprises a plurality of through openings through which the liquid is discharged from the material. Here, the curved screen may be configured as a metal screen or a plastic screen, in particular made of polyurethane. In particular, the curved screen can be configured as a punched plate and/or slotted screen and/or wire mesh.

In particular, an inlet elbow of such type for pre-drying of granulate having a grain size of greater than or equal to 0.2 mm, in particular greater than or equal to 0.5 mm, in particular greater than or equal to 2 mm, in particular greater than or equal to 3 mm, in particular greater than or equal to 4 mm, can be used. The through openings of the curved screen configured as punched plate and/or slotted screen and/or wire mesh are sized accordingly. Therefore, the through openings have a size of less than or equal to 4 mm, in particular less than or equal to 3 mm, in particular less than or equal to 2 mm, in particular less than or equal to 1.5 mm, in particular less than or equal to 1 mm, in particular less than or equal to 0.5 mm, in particular less than or equal to 0.2 mm.

Thus, a curved screen configured as a wire mesh can have a mesh size of 0.2 mm or 0.5 mm or 1.0 mm or 1.5 mm or 2.0 mm or 3 mm or 4 mm. Further, the curved screen may be configured as plastic screen, in particular made of polyurethane.

Preferably, the curved screen comprises multiple through openings running parallel in flow direction and/or at an angle to the flow direction and/or perpendicular to the flow direction side by side, in particular over the entire width of the curved screen or almost over the entire width of the curved screen and/or over side walls of the curved screen. Thus, said through openings may be configured in a slit-shaped manner, the slits running parallel to the flow direction. Alternatively or cumulatively, slit-shaped through openings may also be disposed at an angle to the flow direction and/or perpendicular to the flow direction. Thus, slit-shaped through openings may be arranged parallel in the flow direction and/or at an angle to the flow direction and/or perpendicular to the flow direction. Further, slit-shaped through-openings may be arranged in a V-shaped manner. Furthermore, slit-shaped through openings running parallel to one another may also be arranged offset to one another.

Thus, in the case that multiple through openings of such type run parallel in and/or at an angle to and/or perpendicular to the flow direction, the curved screen is configured as a slotted screen having multiple slit-shaped slots parallel to and/or at an angle to and/or perpendicular to the flow direction of the material to be transported. Here, the slit-shaped slots may be arranged over the entire width of the curved screen or almost over the entire width of the curved screen and/or over side walls of the curved screen in order to increase the effectiveness of the curved screen.

The term width of the curved screen refers to the extension of the curved screen perpendicular to the through-flow direction of the curved screen, i.e. the width of the perpendicular projection of the flow channel in the inlet elbow.

Alternatively or cumulatively, the side walls of the bend may be perforated. Liquid can hereby be removed and discharged via the side walls of the bend.

In a particularly preferred embodiment, the curved screen comprises multiple sections of through openings running parallel in the flow direction and/or at an angle to the flow direction and/or perpendicular to the flow direction, wherein multiple sections are arranged one after another in the flow direction.

Accordingly, in this case the curved screen is configured as a slotted screen, wherein multiple slotted screen sections are arranged one after another in the flow direction and wherein the individual slit-shaped through openings are arranged parallel in flow direction and/or at an angle to the flow direction and/or perpendicular to the flow direction.

Alternatively or cumulatively, the curved screen comprises multiple through openings running parallel in the flow direction and/or at an angle to the flow direction and/or perpendicular to the flow direction, which openings are arranged offset to one another. Further, slit-shaped through openings may be arranged in a V-shaped manner.

Here, the opening width of the slots is adjusted to the grain size of the granulate to be dewatered, i.e. the gap width has a size of in particular less than or equal to 4 mm, in particular less than or equal to 3 mm, in particular less than or equal to 2 mm, in particular less than or equal to 1.5 mm, in particular less than or equal to 1 rnm, in particular less than or equal to 0.5 mm, in particular less than or equal to 0.2 mm.

Preferably, the inlet elbow comprises a first outlet for discharging the material dried via the curved screen, in particular for discharging into a feed of a screen centrifuge.

Preferably, the inlet elbow comprises a second outlet for discharging the liquid removed from the wet material by means of the curved screen.

Accordingly, the inlet elbow preferably comprises two outlets for the separate discharge of pre-dried material into the feed of a screen centrifuge disposed downstream said elbow on the one hand, for example, as well as a second outlet for discharging the liquid to be removed from the material.

Preferably, a screen centrifuge is disposed downstream the inlet elbow.

By means of such a screen centrifuge, the pre-dried granulate may be subjected to a further dewatering. Due to the fact that the inlet elbow is connected upstream said centrifuge and due to the pre-drying of the wet granulate to be dewatered, performance of the screen centrifuge for dewatering the wet granulate is significantly increased.

Accordingly, a screen centrifuge according to the invention is characterized in that it comprises at least one inlet elbow according to the invention, wherein the inlet elbow may be connected upstream of a feed of the screen centrifuge and by means of which wet material to be dried is fed to the screen centrifuge in a pre-dried manner.

As a result of the fact that the wet granulate to be dewatered is pre-dried by means of the inlet elbow, performance of the screen centrifuge is significantly improved as explained above.

In the method for dewatering a wet granulate, in particular a wet plastic granulate, in particular by means of a screen centrifuge, it is particularly advantageous that the wet granulate is channeled through an inlet elbow which comprises a bend with a curved screen by means of which liquid is removed from the wet granulate and discharged.

The granulate to be dewatered may for example be nylon, polyester, polypropylene or pearl polystyrene. However, use of the invention is not limited to said materials. Here, the granulate may for example comprise grain sizes of greater than or equal to 0.2 mm, in particular greater than or equal to 0.5 mm, in particular greater than or equal to 2 mm or greater than or equal to 3 mm or greater than or equal to 4 mm.

In a preferred configuration of the method for dewatering a wet granulate, the wet granulate is fed to a screen centrifuge and dewatered in the screen centrifuge after being channeled through the inlet elbow and being subjected to a pre-drying.

Here, the term dewatering includes the removal of any liquid, the use not being limited to the removal of water. In fact, the method according to the invention may be used for removing any liquid from the wet granulate, in particular also mixtures of water and a solvent.

Here, the term dewatering particularly includes a complete drying of the granulate, i.e. the complete removal of liquid contained in the originally wet granulate. However, said term also includes that a part of the liquid is removed from the wet granulate to be dewatered, wherein a residual content of liquid may remain on the individual granulate particles in the form of a surface wetness after carrying out the method.

An exemplary embodiment of the invention is shown in the drawings and will be explained in further detail as follows. The figures show in:

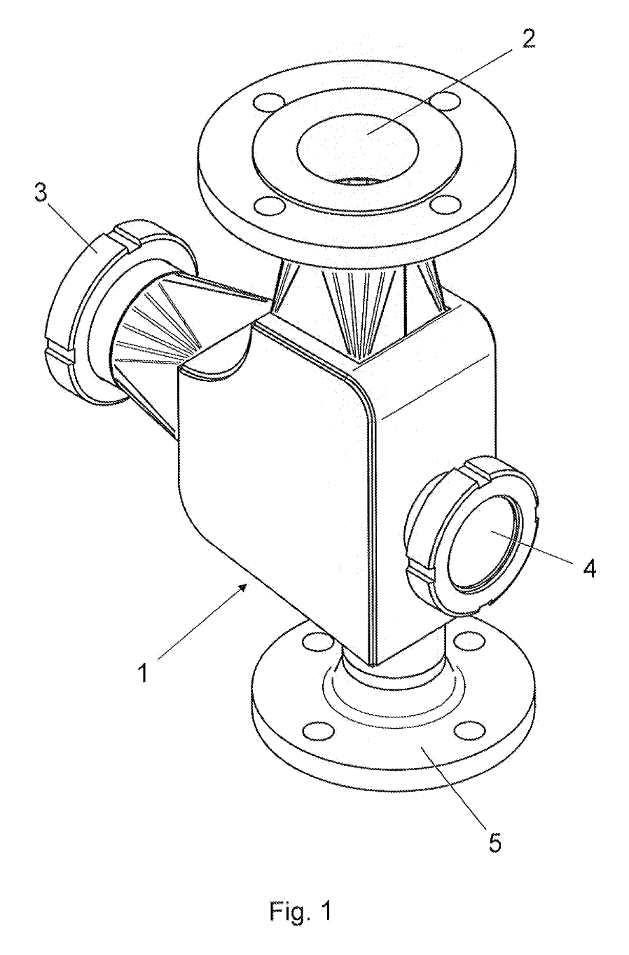

FIG. 1 a perspective view of an inlet elbow;

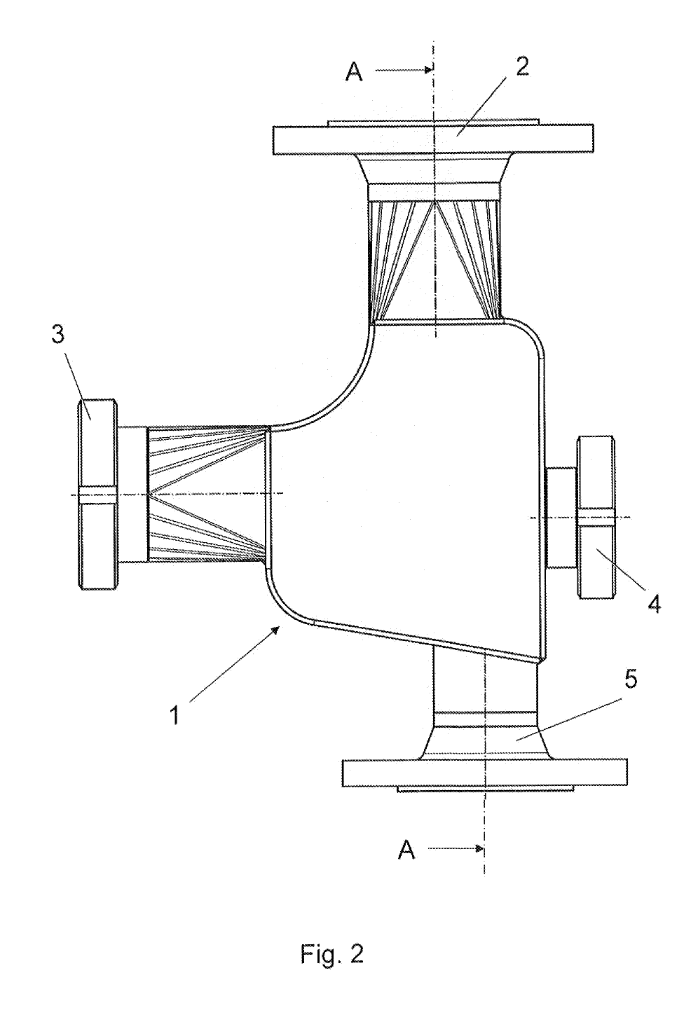

FIG. 2 the side view of the inlet elbow according to FIG. 1;

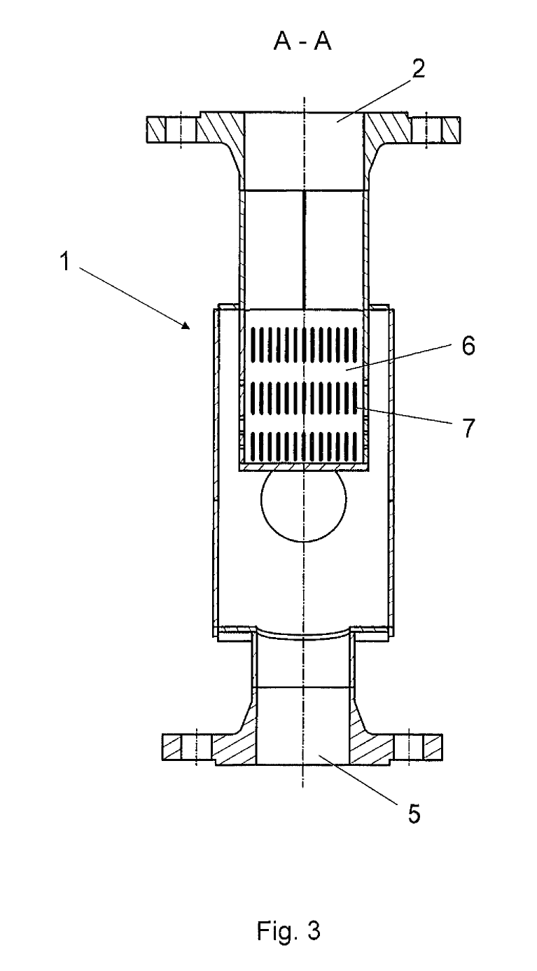

FIG. 3 the sectional view A-A according to FIG. 2;

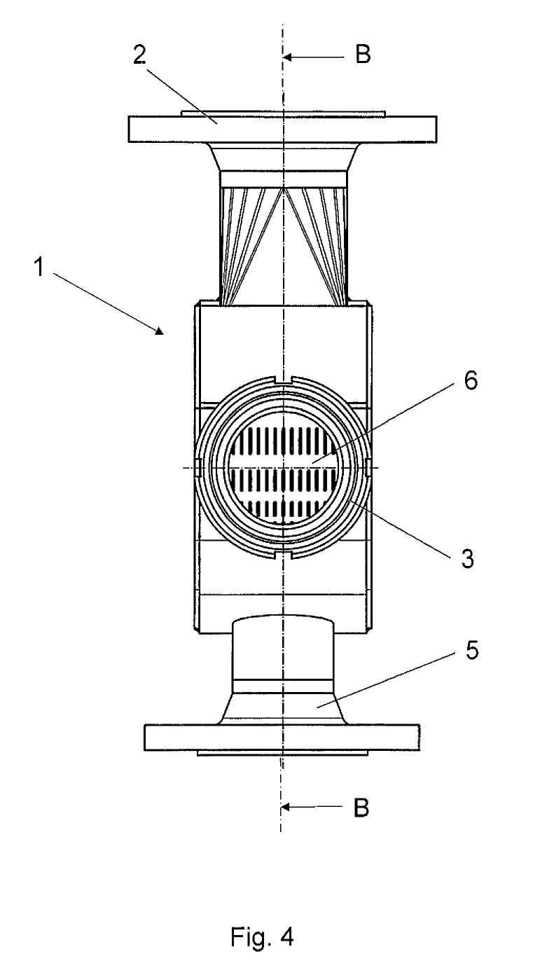

FIG. 4 the front view of the inlet elbow;

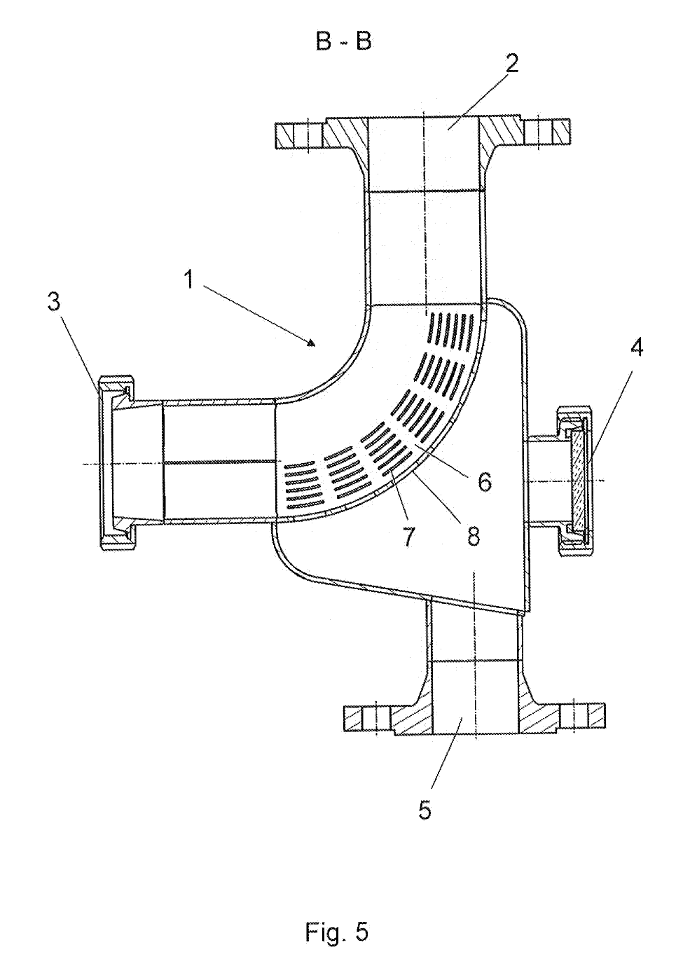

FIG. 5 the sectional view B-B according to FIG. 4.

The figures show an exemplary embodiment of an inlet elbow 1 having a feed 2, by means of which the granulate to be dewatered is fed to the inlet elbow. Inside the inlet elbow, the flow direction of the granulate is deflected by 90°.

The granulate pre-dried by means of the inlet elbow is fed to a screen centrifuge (not shown) connected downstream of said elbow via the first outlet 3. Thus a deflection of the flow direction of the granulate to be dewatered by 90° is effected inside the inlet elbow 1.

The curved screen 6 arranged in the bend 8 and having a plurality of slit-shaped through openings 7 can be discerned in the drawings, which openings are arranged running parallel to one another over the entire width of the curved screen 6, wherein multiple sections of slit-shaped through openings arranged in parallel are arranged one after another in the flow directions as can be seen from FIGS. 3, 4 and 5. As can be seen from FIG. 5, the curved screen configured as slotted screen extends over the entire bend region 8 of the elbow.

On its bottom side, the inlet elbow 1 comprises a second outlet 5 by means of which the liquid removed from the granulate to be dewatered is discharged by means of the inlet elbow 1. At the same time, the second outlet 5 is formed as a mounting flange for fixing the inlet elbow 1 to a pipeline.

The inlet elbow 1 comprises a window 4 on the rear side thereof.

Feed 2, first outlet 3 as well as second outlet 5 each comprise a flange for mounting corresponding pipe connectors.

The screen centrifuge for further dewatering of the granulate pre-dried by means of the inlet elbow 1, which centrifuge is connected downstream the first outlet 3, is not shown in the figures.

The centrifuge performance of the screen centrifuge, which is limited by the amount of liquid, is significantly increased by the pre-drying of the wet granulate by means of the inlet elbow 1.

Here, the wet granulate is conveyed by means of a pump and fed to the inlet elbow at an overpressure as compared to the ambient pressure.

As a result of said overpressure inside the inlet elbow compared to the ambient pressure, pre-drying of the wet granulate in the inlet elbow is improved. The overpressure at the inlet of the inlet elbow compared to the ambient pressure may be up to 2 bar, in particular up to 3 bar or up to 4 bar.

1. An inlet elbow for a screen centrifuge for removing a liquid from a wet material, wherein the inlet elbow (1) comprises a bend (8) in which the wet material to be transported is deflected and wherein the bend (8) comprises a curved screen (6) by means of which liquid is removed from the wet material and is discharged.

2. The inlet elbow (1) according to claim 1, wherein the inlet elbow (1) is gas-tight toward the surroundings.

3. The inlet elbow (1) according to claim 1, wherein the curved screen (6) is formed by a screen that corresponds in its contour to the bend (8) of the inlet elbow (1).

4. The inlet elbow (1) according to claim 1, wherein the curved screen (6) comprises a plurality of through openings (7) through which liquid is discharged from the material.

5. The inlet elbow (1) according to claim 1, wherein the curved screen (6) is configured as a punched plate or slotted screen or wire mesh or polyurethane plastic screen.

6. The inlet elbow (1) according to claim 1, wherein the curved screen (6) comprises multiple through openings (7) running parallel in the flow direction or at an angle to the flow direction or perpendicular to the flow direction, over the entire width of the curved screen (6) or over almost the entire width of the curved screen (6) or over side walls of the curved screen (6).

7. The inlet elbow (1) according to claim 1, wherein the curved screen (6) comprises multiple through openings (7) running parallel in the flow direction or at an angle to the flow direction or perpendicular to the flow direction, the sections being arranged one after another in flow direction.

8. The inlet elbow (1) according to claim 1, wherein the curved screen (6) comprises multiple through openings (7) running parallel in the flow direction or at an angle to the flow direction or perpendicular to the flow direction, the openings being arranged offset or V-shaped to one another.

9. The inlet elbow (1) according to claim 1, wherein the inlet elbow (1) comprises a feed (2) (2) comprising a flange.

10. The inlet elbow (1) according to claim 1, wherein the inlet elbow (1) comprises a first outlet (3) for discharging the de-wetted material into a feed of a screen centrifuge.

11. The inlet elbow (1) according to claim 1, wherein the inlet elbow (1) comprises a second outlet (5) for discharging the liquid removed from the wet material by means of the curved screen (6).

12. The inlet elbow (1) according to claim 1, wherein a screen centrifuge is disposed downstream the inlet elbow (1).

13. A screen centrifuge, wherein said centrifuge comprises at least one inlet elbow (1) according to claim 1 disposed upstream of a feed of the screen centrifuge and by means of which wet material is fed to the screen centrifuge in a pre-dried manner.

14. A method for dewatering a wet granulate, in particular a wet plastic granulate, by means of a screen centrifuge, wherein the wet granulate is channeled through an inlet elbow (1) comprising a bend (8) with a curved screen (6), by means of which liquid is removed from the wet granulate and discharged.

15. The method according to claim 14, characterized in that the wet granulate, after being channeled through the inlet elbow (1) and subjected to pre-drying, is fed to a screen centrifuge and dewatered in the screen centrifuge.

16. The method according to claim 14, wherein the wet granulate is conveyed by means of a pump and in that it is fed to the inlet elbow at an overpressure as compared to the ambient pressure.

17. The method according to 15, wherein the wet granulate is conveyed by means of a pump and in that it is fed to the inlet elbow at an overpressure as compared to the ambient pressure.

18. The inlet elbow (1) according to claim 2 wherein the curved screen (6) is formed by a screen that corresponds in its contour to the bend (8) of the inlet elbow (1).

19. The inlet elbow (1) according to claim 2 wherein the curved screen (6) comprises a plurality of through openings (7) through which liquid is discharged from the material.

20. The inlet elbow (1) according to claim 2 wherein the curved screen (6) is configured from the group consisting of punched plates, slotted screens, wire meshes and plastic screens and wherein the curved screen (6) further comprises multiple through openings (7) running parallel in the flow direction and/or at an angle to the flow direction and/or perpendicular to the flow direction over the entire width of the curved screen (6) or over almost the entire width of the curved screen (6) and/or over side walls of the curved screen.
